(19) United States
(12) Patent Application Publication
(10) Pub. No.: US 2022/0263141 A1
(43) Pub. Date: Aug. 18, 2022

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideo TAKAHASHI, Mie (JP); Shinichi TAKASE, Mie (JP); Hiroki SHIMODA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 17/628,360

(22) PCT Filed: Jul. 10, 2020
(86) PCT No.: PCT/JP2020/027041

§ 371 Date: Jan. 19, 2022

(30) Foreign Application Priority Data
Jul. 31, 2019 (JP) 2019-141130
Oct. 29, 2019 (JP) 2019-196048

(51) Int. Cl. H01M 10/42; H01M 10/48; H01M 50/204; H01M 50/507

(52) U.S. Cl. CPC H01M 10/425; H01M 10/482; H01M 2220/20; H01M 50/204; H01M 50/507; H01M 10/486

(57) ABSTRACT

A wiring module disposed on a plurality of power storage devices that have electrode terminals, the wiring module including: at least one flexible first substrate that is electrically connected to the electrode terminals; and a flexible second substrate that is electrically connected to the first substrate and a device, wherein a plurality of first voltage detection lines that are electrically connected to the electrode terminals are formed on the first substrate, and the plurality of first voltage detection lines are not lined up in the order of the potentials of the electrode terminals to which the plurality of first voltage detection lines are connected, a plurality of second voltage detection lines that are connected to the plurality of first voltage detection lines are formed on the second substrate, and the second substrate has a connection end portion that is connected to the device.

### TECHNICAL FIELD

The present disclosure relates to a wiring module.

### BACKGROUND ART

A wiring module that is attached to a plurality of power storage devices is conventionally known. In the wiring module, a plurality of voltage detection lines are formed on a flexible substrate. The plurality of voltage detection lines are electrically connected to electrode terminals of the power storage devices. The plurality of voltage detection lines are connected to a device, and the voltages of the power storage devices are detected by the device. As such a wiring module, the wiring module disclosed in International Publication No. 2014/024452 is known, for example.

### CITATION LIST

### Patent Documents

Patent Document 1: International Publication No. 2014/024452

### SUMMARY OF INVENTION

### Technical Problem

In a power storage device, electrode terminals for the positive and negative electrodes may be formed separated from one another at both end portions of the power storage device in the width direction. Furthermore, as a result of a plurality of power storage devices being connected in series or in parallel, electrode terminal potentials may differ among individual power storage devices in a complicated fashion. In such a case, in a wiring module attached to a plurality of power storage devices, voltage detection lines connected to electrode terminals may be lined up in an order that is different from the order of the potentials of the electrode terminals to which the voltage detection lines are connected (see FIG. 4 of International Publication No. 2014/024452).

On the other hand, inside a device that detects power storage device voltages, terminals of a microcomputer or a circuit for detecting voltages may be formed in the order of potential. In view of this, it is conceivable to rearrange, in the order of potential, voltage detection lines that are arranged irrespective of potential.

For example, it is conceivable to use jumper wires in order to arrange voltage detection lines in the order of potential on a flexible substrate. However, this technique increases the number of components and wiring complexity, and may thereby increase the wiring-module production cost.

The present disclosure has been made based on the above-described circumstances, and aims to reduce the wiring-module production cost.

### Solution to Problem

The present disclosure provides a wiring module disposed on a plurality of power storage devices that have electrode terminals, the wiring module including; at least one flexible first substrate that is electrically connected to the electrode terminals; and a flexible second substrate that is electrically connected to the first substrate and a device, wherein a plurality of first voltage detection lines that are electrically connected to the electrode terminals are formed on the first substrate, and the plurality of first voltage detection lines are not lined up in the order of the potentials of the electrode terminals to which the plurality of first voltage detection lines are connected, a plurality of second voltage detection lines that are connected to the plurality of first voltage detection lines are formed on the second substrate, and the second substrate has a connection end portion that is connected to the device, and in the connection end portion, the plurality of second voltage detection lines are lined up in the order of the potentials of the electrode terminals to which the plurality of second voltage detection lines are electrically connected via the plurality of first voltage detection lines.

### Advantageous Effects of Invention

The wiring-module production cost can be reduced according to the present disclosure.

### BRIEF DESCRIPTION OF DRAWINGS

FIG. 1 is a schematic diagram illustrating a vehicle in which a power storage module according to embodiment 1 is installed.

FIG. 2 is a plan view illustrating the power storage module according to embodiment 1.

FIG. 3 is a plan view illustrating a first substrate.

FIG. 4 is a plan view illustrating a second substrate.

FIG. 5 is a partially-enlarged cross-sectional view illustrating a connection structure between the first and second substrates.

FIG. 6 is a plan view illustrating a power storage module according to a hypothetical technique.

FIG. 7 is a plan view illustrating a power storage module according to embodiment 2.

FIG. 8 is a partially-enlarged plan view illustrating a reference protrusion inserted into first and second reference holes and a holding protrusion inserted into an elongated hole.

FIG. 9 is a partially-enlarged cross-sectional view illustrating the reference protrusion inserted into the first and second reference holes and the holding protrusion inserted into the elongated hole.

### DESCRIPTION OF EMBODIMENTS

### Description of Embodiments of Present Disclosure

First, aspects of the present disclosure will be listed and described.

(1) The present disclosure provides a wiring module disposed on a plurality of power storage devices that have electrode terminals, the wiring module including: at least one flexible first substrate that is electrically connected to the electrode terminals; and a flexible second substrate that is electrically connected to the first substrate and a device, wherein a plurality of first voltage detection lines that are electrically connected to the electrode terminals are formed on the first substrate, and the plurality of first voltage detection lines are not lined up in the order of the potentials of the electrode terminals to which the plurality of first voltage detection lines are connected, a plurality of second voltage detection lines that are connected to the plurality of first voltage detection lines are formed on the second substrate, and the second substrate has a connection end portion that is connected to the device, and in the connection end portion, the plurality of second voltage detection lines are lined up in the order of the potentials of the electrode terminals to which the plurality of second voltage detection lines are electrically connected via the plurality of first voltage detection lines.

According to the above-described configuration, the plurality of second voltage detection lines can be arranged lined up in the order of the potentials of the power storage devices in the connection end portion of the second substrate by employing a simple technique of connecting the first and second substrates. The wiring-module production cost can thus be reduced.

(2) Preferably, a first conduction path that is different from the first voltage detection lines and that is not lined up in the order of potential is formed on the first substrate, a second conduction path that is different from the second voltage detection lines and that is electrically connected to the first conduction path is formed on the second substrate, and the position of the second conduction path in the connection end portion is different from the position of the first conduction path on the first substrate.

According to the above-described configuration, the position of the first conduction path, which is not lined up in the order of potential on the first substrate, and the position of the second conduction path in the connection end portion of the second substrate can be varied. Thus, the flexibility of design can be improved in terms of the position of the first conduction path on the first substrate and the position of the second conduction path on the second substrate.

(3) Preferably, a temperature measurement sensor that detects the temperature of the power storage devices is connected to the first conduction path, and the second conduction path is disposed near the second voltage detection line having the lowest potential out of the plurality of second voltage detection lines.

The potential of the second conduction path and the first conduction path connected to the temperature measurement sensor is relatively close to the lowest one of the potentials of the second voltage detection lines. Thus, the second voltage detection lines and the second conduction path can be arranged so as to substantially be lined up in the order of potential in the connection end portion.

(4) Preferably, the first and second substrates are electrically connected via solder.

The wiring-module production cost can be reduced because the first and second substrates can be electrically connected by employing soldering, which is a simple technique.

(5) Preferably, the solder is covered by a sealing portion that contains an insulative synthetic resin.

According to the above-described configuration, the wiring-module production cost can be reduced because the solder can be sealed by employing a simple technique of covering the solder with a synthetic resin.

(6) Preferably, the first substrate has a front surface and a back surface, and the first voltage detection lines are formed only on the front surface of the first substrate, and the second substrate has a front surface and a back surface, and the second voltage detection lines are formed only on the front surface of the second substrate.

Flexible substrates on which conduction paths are formed only on one side thereof can be used as the first and second substrates because the first voltage detection lines and the second voltage detection lines are respectively formed only on the front surface of the first substrate and the front surface of the second substrate. The wiring-module production cost can thus be reduced.

(7) Preferably, the first and second substrates are disposed on an insulative protector, a first reference hole and a second reference hole that respectively penetrate the first substrate and the second substrate are provided so as to be aligned with one another in an overlap region in which the first and second substrates overlap, an elongated hole that has an elongated shape in an extension direction in which the first substrate extends is provided in a region of the first substrate that is different from the overlap region, and the protector has a reference protrusion that is inserted into the first and second reference holes and that holds the first and second substrates in a locked state, and a holding protrusion that is inserted into the elongated hole and that holds the first substrate so as to be movable in the extension direction.

The first and second substrates are prevented from moving relative to one another because the first and second substrates are held in a locked state in the overlap region by the reference protrusion inserted into the first and second reference holes. The reliability of the electrical connection between the first and second substrates can thus be improved.

The first substrate can move in the extension direction relative to the protector because the holding protrusion of the protector is inserted into the elongated hole extending in the extension direction of the first substrate. Thus, misalignment between the first substrate and the protector can be addressed.

(8) The wiring module may be a wiring module for vehicles that is to be used installed in a vehicle.

### Details of Embodiments of Present Disclosure

Embodiments of the present disclosure will be described in the following. The present invention is not limited to these examples, and is intended to include all modifications that are indicated by the claims and are within the meaning and scope of equivalents of the claims.

### Embodiment 1

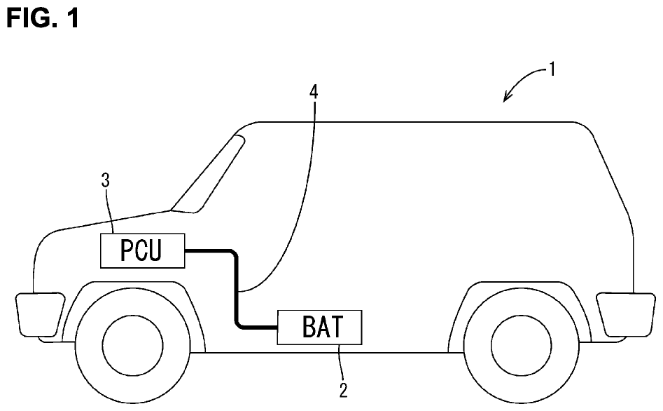

Embodiment 1, in which the present disclosure is applied to a battery pack 2 installed in a vehicle 1, will be described with reference to FIGS. 1 to 6. The battery pack 2 is installed in the vehicle 1, which is an electric automobile, a hybrid automobile, or the like, and is used as a motive power source of the vehicle 1. In the following description, when more than one of a given member is provided, the reference symbol therefor may be provided to only some of the members and may be omitted for the rest.

### Overall Configuration

As illustrated in FIG. 1, the battery pack 2 is disposed near the center of the vehicle 1. A power control unit (PCU) 3 is disposed in the front part of the vehicle 1. The battery pack 2 and the PCU 3 are connected via a wire harness 4. The battery pack 2 and the wire harness 4 are connected via an unshown connector. The battery pack 2 includes a power storage module 10 that includes a plurality of power storage devices 11.

The power storage module 10 according to the present embodiment includes the plurality of power storage devices 11, a wiring module 12, and a device 13. In the following description, the direction indicated by the arrow Z is regarded as the upward direction, the direction indicated by the arrow Y is regarded as the forward direction, and the direction indicated by the arrow X is regarded as the rightward direction. Furthermore, when more than one of the same member is provided, the reference symbol therefor may be provided to only some of the members and may be omitted for the rest.

### Power Storage Module 10

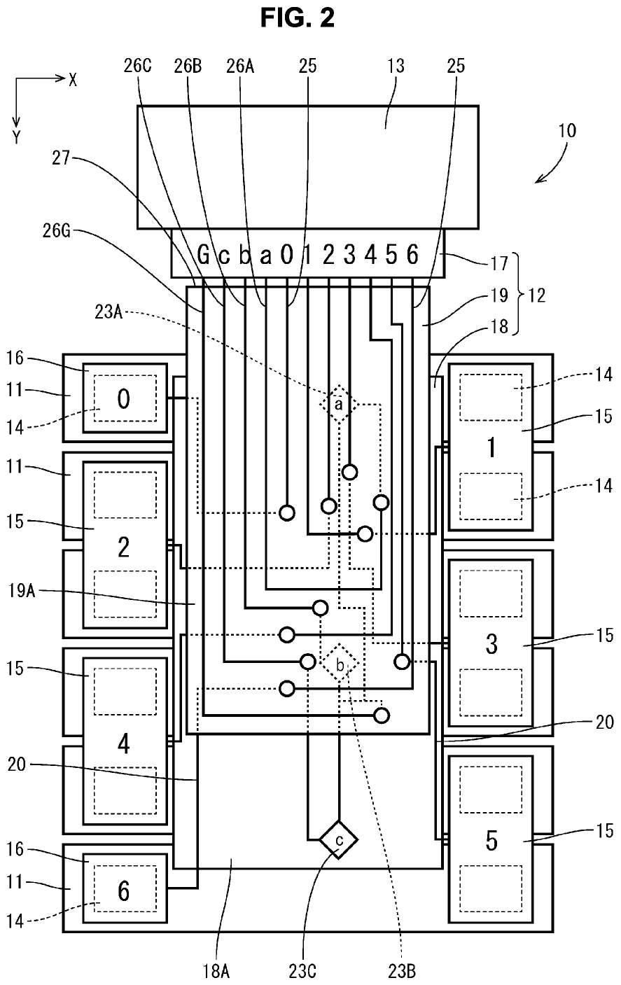

As illustrated in FIG. 2, in the power storage module 10, a plurality of power storage devices 11 (five in the present embodiment) are lined up in the front-rear direction. The power storage devices 11 each have a rectangular shape. An unshown power storage element is housed inside each power storage device 11. The power storage devices 11 are not particularly limited, and may be secondary batteries or capacitors. The power storage devices 11 according to the present embodiment are secondary batteries.

Electrode terminals 14 are formed on the left and right end portions of the upper surface of each power storage device 11. One of the electrode terminals 14 is a positive electrode, and the other is a negative electrode. A connection bus bar 15 or an output bus bar 16 is electrically connected to each electrode terminal 14.

### Connection Bus Bar 15 and Output Bus Bar 16

The connection bus bar 15 and the output bus bar 16 are obtained by pressing metal plates into predetermined shapes. A metal such as copper, a copper alloy, aluminum, or an aluminum alloy can be appropriately selected as the metal for forming the metal plates. An unshown plating layer may be formed on the surface of the connection bus bar 15 and the output bus bar 16. A metal such as tin, nickel, or solder can be appropriately selected as the metal for forming the plating layer.

The connection bus bar 15 is connected to electrode terminals 14 in a state in which the connection bus bar 15 bridges electrode terminals 14 that are adjacent to one another. The output bus bar 16 is connected to one electrode terminal 14 and outputs electric power to an external device. There are two output bus bars 16 in the present embodiment, one being connected to an electrode terminal 14 formed on the left end portion of a power storage device 11 in the rearmost row and the other being connected to an electrode terminal 14 formed on the left end portion of a power storage device 11 in the frontmost row. In the present embodiment, five connection bus bars 15 connect electrode terminals 14 that are adjacent to one another. The plurality of power storage devices 11 are connected in series by these connection bus bars 15.

The electrode terminals 14 and the output bus bars 16/connection bus bars 15 are electrically and physically connected by employing a known technique such as soldering, welding, or bolting.

In FIG. 2, the numerals “0” to “6” appended to the connection bus bars 15 and the output bus bars 16 indicate the ranks of the potentials of the plurality of power storage devices 11 to which the connection bus bars 15 and the output bus bars 16 are connected. The potential of the electrode terminal 14 to which the output bus bar 16 having the numeral “0” appended thereto is connected is the lowest, and the potentials increase in order from “1” to “5” and to the potential of the electrode terminal 14 to which the output bus bar 16 having the numeral “6” appended thereto is connected, which is the highest.

As illustrated in FIG. 2, the ranks of the potentials of the electrode terminals 14 connected to the output bus bars 16 and the connection bus bars 15 disposed on the left end portions of the plurality of power storage devices 11 lined up in the front-rear direction are “0”, “2”, “4”, and “6”, and the ranks of the potentials of the electrode terminals 14 connected to the connection bus bars 15 disposed on the right end portions of the plurality of power storage devices 11 are “1”, “3”, and “5”. In such a manner, the potentials of the electrode terminals 14 are lined up in order from the lowest potential in an alternating fashion on the right and left sides.

### Device 13

While not shown in detail, the device 13 includes a microcomputer or a circuit for voltage detection. A module-side connector 17 provided in a connection end portion of the wiring module 12 is connected to the device 13.

### Wiring Module 12

As illustrated in FIG. 2, the wiring module 12 is mounted on the upper surfaces of the plurality of power storage devices 11. The wiring module 12 according to the present embodiment includes a flexible first substrate 18, a flexible second substrate 19, and the module-side connector 17, which is connected to the second substrate 19.

### First Substrate 18

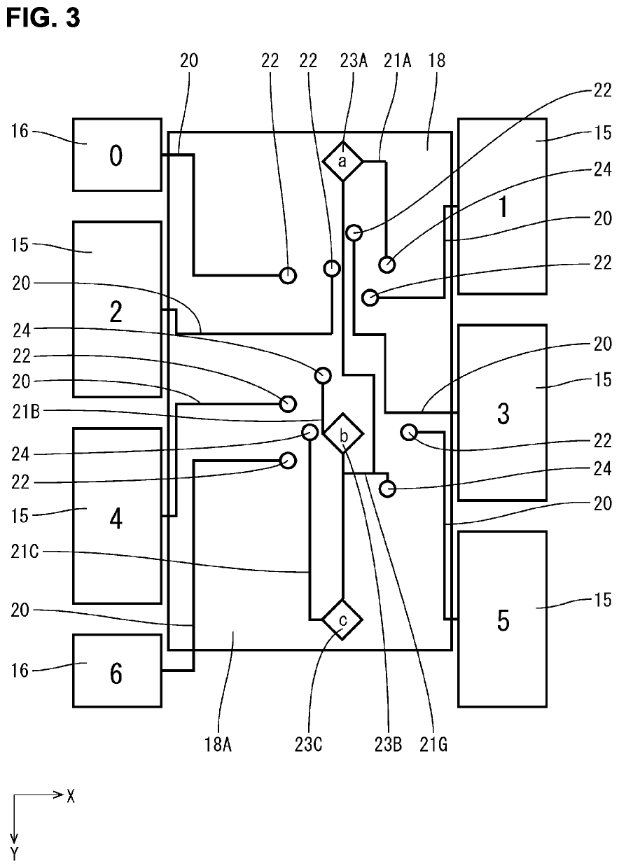

As illustrated in FIG. 3, the first substrate 18 is a flexible printed circuit board in which first voltage detection lines 20 and a first temperature measurement conduction path 21 (one example of a first conduction path) are formed on a front surface 18A of a flexible insulative sheet by employing printed wiring technology.

The first substrate 18 is formed so as to extend in an elongated fashion in the front-rear direction. No other conduction paths including the first voltage detection lines 20 and first temperature measurement conduction path 21 are formed on a back surface 18B of the first substrate 18.

A plurality of first voltage detection lines 20 (seven in the present embodiment) are formed on the first substrate 18. One end portion of each first voltage detection line 20 is connected to a connection bus bar 15 or an output bus bar 16. The first voltage detection lines 20 and the connection bus bars 15/output bus bars 16 are electrically and physically connected by employing a suitable technique such as soldering or welding.

As illustrated in FIG. 2, the electrode terminals 14 are lined up in an alternating fashion on the left and right sides of the plurality of power storage devices 11, which are arranged so as to be lined up in the front-rear direction. Thus, while the four first voltage detection lines 20 that are formed close to the left end portion of the first substrate 18 are arranged in the order of potential from the rear toward the front when these four first voltage detection lines 20 are compared with one another for example, the four first voltage detection lines 20 that are formed close to the left end portion of the first substrate 18 and the three first voltage detection lines 20 that are formed close to the right end portion of the first substrate 18 are not formed so as to be lined up in the order of the potentials of the electrode terminals 14 to which the plurality of first voltage detection lines 20 are connected when the first substrate 18 is seen as a whole.

End portions of the four first voltage detection lines 20 that are formed close to the left end portion of the first substrate 18 that are different from the end portions thereof connected to the output bus bars 16/connection bus bars 15 are wired to a region that is close to the center of the first substrate 18 in the left-right direction and that is close to the center of the first substrate 18 in the front-rear direction, to form first voltage detection lands 22.

End portions of the four first voltage detection lines 20 that are formed close to the right end portion of the first substrate 18 that are different from the end portions thereof connected to the connection bus bars 15 are wired to a region that is close to the center of the first substrate 18 in the left-right direction and that is close to the center of the first substrate 18 in the front-rear direction, to form first voltage detection lands 22.

As illustrated in FIG. 3, the first temperature measurement conduction path 21, which is different from the first voltage detection lines 20, is formed on the front surface 18A of the first substrate 18 by employing printed wiring technology. A rear thermistor 23A (one example of a temperature measurement sensor) that is disposed in the rear part of the first substrate 18, a front thermistor 23C (one example of a temperature measurement sensor) that is disposed in the front part of the first substrate 18, and a middle thermistor 23B (one example of a temperature measurement sensor) that is disposed at a position between the rear thermistor 23A and the front thermistor 23C are connected in parallel to the first temperature measurement conduction path 21.

The first temperature measurement conduction path 21 includes a front first temperature measurement conduction path 21C that is provided on the device 13 side of the front thermistor 23C, a middle first temperature measurement conduction path 21B that is provided on the device 13 side of the middle thermistor 23B, and a rear first temperature measurement conduction path 21A that is provided on the device 13 side of the rear thermistor 23A. The first temperature measurement conduction path 21 further includes a ground first temperature measurement conduction path 21G that is provided in the front thermistor 23C, the middle thermistor 23B, and the rear thermistor 23A on the side opposite from the device 13.

As illustrated in FIG. 3, an end of the front first temperature measurement conduction path 21C that is on the opposite side from the front thermistor 23C is wired to a position that is located rearward of the front thermistor 23C. An end of the middle first temperature measurement conduction path 21B that is on the opposite side from the middle thermistor 23B is wired to a position that is located slightly rearward of the middle thermistor 23B. An end of the rear first temperature measurement conduction path 21A that is on the opposite side from the rear thermistor 23A is wired to a position that is located forward of the rear thermistor 23A. The end of the front first temperature measurement conduction path 21C, the end of the middle first temperature measurement conduction path 21B, the end of the rear first temperature measurement conduction path 21A, and an end of the ground first temperature measurement conduction path 21G form first temperature measurement lands 24.

### Second Substrate 19

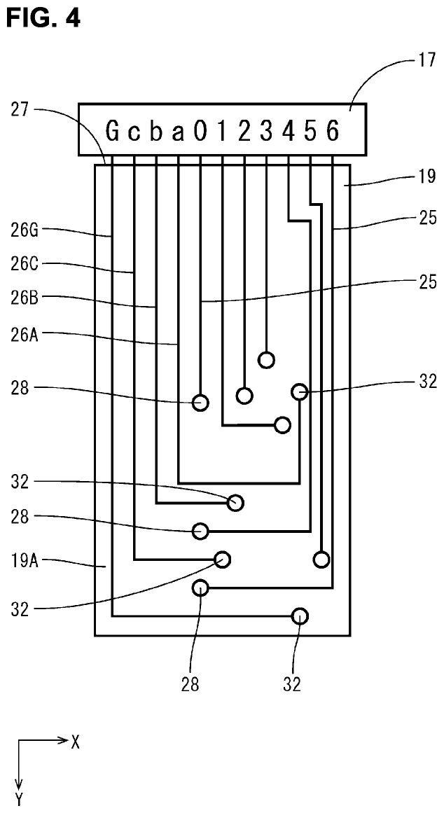

As illustrated in FIG. 2, the second substrate 19 is placed on top of the first substrate 18. As illustrated in FIG. 4, the second substrate 19 is a flexible printed circuit board in which second voltage detection lines 25 and second temperature measurement conduction paths 26 (one example of second conduction paths) are formed on a front surface 19A of a flexible insulative sheet by employing printed wiring technology. The second substrate 19 is formed so as to extend in an elongated fashion in the front-rear direction. Generally, the second voltage detection lines 25 and the second temperature measurement conduction paths 26 are formed so as to be lined up at intervals in the left-right direction and extend in the front-rear direction on the front surface 19A of the second substrate 19. No other conduction paths including the second temperature measurement conduction paths 26 and second voltage detection lines 25 are formed on a back surface 19B of the second substrate 19.

The module-side connector 17 is connected to the rear end portion of the second substrate 19. The rear end portion of the second substrate 19 is a connection end portion 27 that is connected to the device 13 via the module-side connector 17.

A plurality of second voltage detection lines 25 (seven in the present embodiment) are formed on the second substrate 19. The second voltage detection lines 25 are formed so as to be lined up from the right end portion of the second substrate 19 toward the left at intervals in the left-right direction and extend in the front-rear direction. The rear end portions of the second voltage detection lines 25 are disposed in the connection end portion 27 of the second substrate 19 so as to be lined up in the left-right direction. Second voltage detection lands 28 are formed at the front end portions of the second voltage detection lines 25.

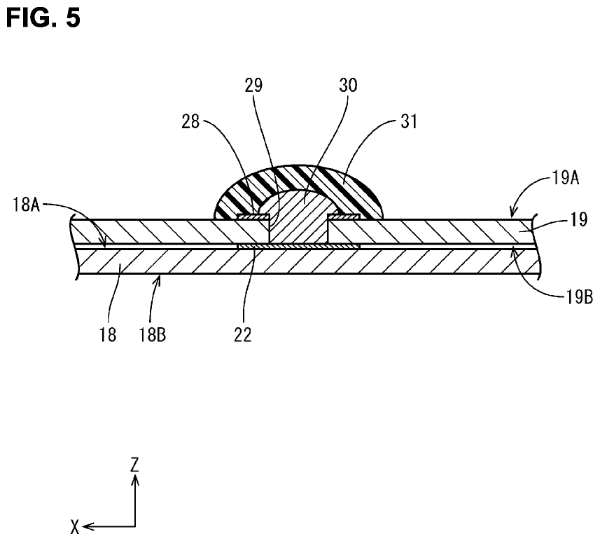

As illustrated in FIG. 5, the second voltage detection lands 28 of the second substrate 19 are positioned above the first voltage detection lands 22 of the first substrate 18. Through-holes 29 penetrating the second voltage detection lands 28 in the top-bottom direction are formed in the second voltage detection lands 28. In a state in which the first substrate 18 and the second substrate 19 are placed one on top of another, the first voltage detection lands 22 of the first substrate 18 are exposed via the through-holes 29.

The through-holes 29 are filled with solder 30 that has solidified after being melted, and the lower parts of the solder 30 are in contact with the first voltage detection lands 22 of the first substrate 18. The solder 30 leaks out from the hole edges of the through-holes 29 and comes in contact with the second voltage detection lands 28. Thus, the first voltage detection lands 22 of the first substrate 18 and the second voltage detection lands 28 of the second substrate 19 are electrically and physically connected.

As illustrated in FIG. 5, the upper parts of the solder 30 are covered by sealing portions 31 that are made of an insulative synthetic resin. The solder 30 is thus protected from dust and moisture.

As illustrated in FIG. 4, a plurality of second temperature measurement conduction paths 26 (four in the present embodiment), which are different from the second voltage detection lines 25, are formed on the front surface 19A of the second substrate 19 by employing printed wiring technology. The rear end portions of the second temperature measurement conduction paths 26 are disposed in the connection end portion 27 of the second substrate 19 so as to be lined up in the left-right direction. Second temperature measurement lands 32 are formed at the front end portions of the second temperature measurement conduction paths 26.

The first temperature measurement lands 24 of the first substrate 18 and the second temperature measurement lands 32 of the second substrate 19 are electrically and physically connected in a similar manner as in the above-described connection structure between the first voltage detection lands 22 and the second voltage detection lands 28, and thus redundant description is omitted.

Out of the second temperature measurement conduction paths 26, the second temperature measurement conduction path 26 that is connected to the rear first temperature measurement conduction path 21A via a second temperature measurement land 32, the solder 30, and a first temperature measurement land 24 is a rear second temperature measurement conduction path 26A, the second temperature measurement conduction path 26 that is connected to the middle first temperature measurement conduction path 21B via a second temperature measurement land 32, the solder 30, and a first temperature measurement land 24 is a middle second temperature measurement conduction path 26B, the second temperature measurement conduction path 26 that is connected to the front first temperature measurement conduction path 21C via a second temperature measurement land 32, the solder 30, and a first temperature measurement land 24 is a front second temperature measurement conduction path 26C, and the second temperature measurement conduction path 26 that is connected to the ground first temperature measurement conduction path 21G via a second temperature measurement land 32, the solder 30, and a first temperature measurement land 24 is a ground second temperature measurement conduction path 26G.

### Wiring Structure of Second Substrate 19

In the connection end portion 27 of the second substrate 19, the second temperature measurement conduction paths 26 and the second voltage detection lines 25 are disposed so as to be lined up in the left-right direction. The second temperature measurement conduction paths 26 are disposed so as to be lined up at intervals in order from the left end portion of the second substrate 19, and the second voltage detection lines 25 are disposed on the right side of the second temperature measurement conduction paths 26.

The second voltage detection lines 25 disposed in the connection end portion 27 of the second substrate 19 are each electrically connected to an electrode terminal 14 via a second voltage detection land 28, the solder 30, a first voltage detection land 22, a first voltage detection line 20, and an output bus bar 16 or a connection bus bar 15. The numerals appended to the second voltage detection lines 25 disposed in the connection end portion 27 indicate the ranks of the potentials of the electrode terminals 14 electrically connected to these second voltage detection lines 25.

The numeral “6” is appended to the second voltage detection line 25 disposed in the right end portion of the connection end portion 27 of the second substrate 19, and this second voltage detection line 25 has the highest potential of the seven second voltage detection lines 25. The potentials of the second voltage detection lines 25 decrease in order from “6” to “0” from the right end portion of the connection end portion 27 toward the left. The difference in potential between adjacent second voltage detection lines 25 corresponds to the electromotive force of one power storage device 11. Thus, the creepage distance between adjacent second voltage detection lines 25 according to the present embodiment can be reduced compared to a case in which the difference in potential between adjacent second voltage detection lines 25 corresponds to the electromotive forces of two or more power storage devices 11.

In the connection end portion 27 of the second substrate 19, the second voltage detection line 25 to which “0” is appended has the lowest potential. The potential of the second voltage detection line 25 to which “0” is appended serves as a reference in the power storage module 10 according to the present embodiment. The potential of the second voltage detection line 25 to which “0” is appended may be the ground potential, i.e., 0 V. If the power storage module 10 according to the present embodiment and another power storage module 10 are connected in series, the potential of the second voltage detection line 25 to which “0” is appended may exceed 0 V because the potential of the second voltage detection line 25 is based on the relative difference in potential from the other power storage module 10.

The ground second temperature measurement conduction path 26G is disposed in the left end portion of the connection end portion 27 of the second substrate 19, and on the right side of the ground second temperature measurement conduction path 26G, the front second temperature measurement conduction path 26C, the middle second temperature measurement conduction path 26B, and the rear second temperature measurement conduction path 26A are disposed in order from the left.

The potential of the ground second temperature measurement conduction path 26G is the ground potential, i.e., 0 V. In the connection end portion 27, the potentials of the rear second temperature measurement conduction path 26A, the middle second temperature measurement conduction path 26B, and the front second temperature measurement conduction path 26C, to which the reference symbols “a”, “b”, and “c” are respectively appended, are based on the resistance values of the rear thermistor 23A, the middle thermistor 23B, and the front thermistor 23C, respectively.

### Production Process According to Present Embodiment

Next, one example of a production process of the power storage module 10 according to the present embodiment will be described. The production process of the power storage module 10 is not limited to the following description.

The plurality of power storage devices 11 are arranged so as to be lined up in the front-rear direction. The output bus bars 16 and the connection bus bars 15 are connected to the electrode terminals 14 of the power storage devices 11.

The front thermistor 23C, the middle thermistor 23B, and the rear thermistor 23A are connected to the first substrate 18. The second substrate 19 is placed on top of the first substrate 18. The first voltage detection lands 22 and the second voltage detection lands 28 are soldered together, and the first temperature measurement lands 24 and the second temperature measurement lands 32 are also soldered together. The solder 30 is sealed with the sealing portions 31.

The module-side connector 17 is connected to the connection end portion 27 of the second substrate 19. The production of the wiring module 12 is thus completed.

The wiring module 12 is disposed on the plurality of power storage devices 11 arranged so as to be lined up in the front-rear direction. The first voltage detection lines 20 of the first substrate 18 are each connected to an output bus bar 16 or a connection bus bar 15. The module-side connector 17 is connected to the device 13. The production of the power storage module 10 is thus completed.

### Actions and Effects of Present Embodiment

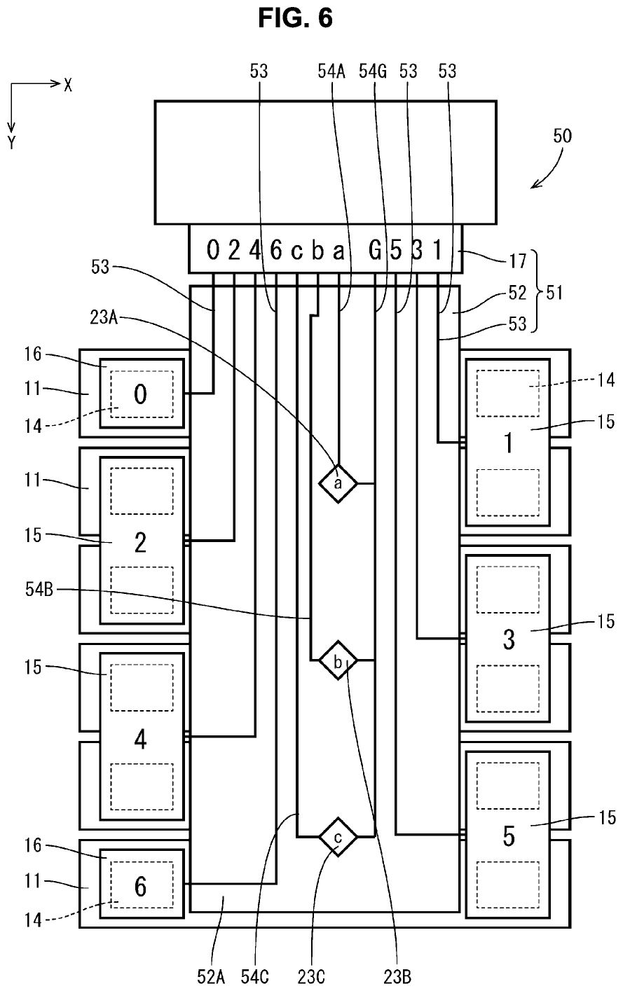

Before describing the actions and effects of the present embodiment, a problem with the prior art will be described using a power storage module 50 according to a hypothetical technique illustrated in FIG. 6. Unless specifically mentioned, the same reference symbols as those used in the present embodiment are used in FIG. 6.

A wiring module 51 according to the hypothetical technique is provided with, on a front surface 52A of one flexible substrate 52: a plurality of voltage detection lines 53 that are each connected to an output bus bar 16 or a connection bus bar 15; a front temperature measurement conduction path 54C, a middle temperature measurement conduction path 54B, and a rear temperature measurement conduction path 54A that are respectively connected to a front thermistor 23C, a middle thermistor 23B, and a rear thermistor 23A; and a ground temperature measurement conduction path 54G that is connected in parallel with the front thermistor 23C, the middle thermistor 23B, and the rear thermistor 23A.

In a connection end portion 27 of the substrate 52 that is connected to a module-side connector 17, the plurality of voltage detection lines 53, the front temperature measurement conduction path 54C, the middle temperature measurement conduction path 54B, the rear temperature measurement conduction path 54A, and the ground temperature measurement conduction path 54G are disposed so as to be lined up at intervals in the left-right direction. As illustrated in FIG. 6, the voltage detection lines 53 lined up in the left-right direction are not lined up in the order of the potentials of the electrode terminals 14 to which the voltage detection lines 53 are electrically connected. Furthermore, there are cases in which the front thermistor 23C, the middle thermistor 23B, and the rear thermistor 23A are disposed in an inner portion of the substrate because the front thermistor 23C, the middle thermistor 23B, and the rear thermistor 23A are for detecting the temperatures of the power storage devices 11. Thus, the voltage detection line 53 having the next-to-highest potential is disposed on the right side of the ground temperature measurement conduction path 54G, and the voltage detection line 53 to which the numeral “6” is appended having the highest potential is disposed on the left side of the front temperature measurement conduction path 54C.

In the device 13, potentials of the voltage detection lines 53 are detected, and the temperatures of the power storage devices 11 are detected from the currents or voltages applied to the front temperature measurement conduction path 54C, the middle temperature measurement conduction path 54B, and the rear temperature measurement conduction path 54A. In this case, terminals of an unshown microcomputer or detection circuit disposed inside the device 13 are formed in the order of potential. Thus, it is conceivable to rewire the voltage detection lines 53, the front temperature measurement conduction path 54C, the middle temperature measurement conduction path 54B, and the rear temperature measurement conduction path 54A input from the module-side connector 17. In doing so, it is conceivable to use a known technique such as jumper wires, for example. However, this technique brings about an increase in the number of components and wiring complexity, etc., and may thereby increase the production cost of the wiring module 12.

In view of this, the present embodiment is configured as a wiring module 12 disposed on a plurality of power storage devices 11 that have electrode terminals 14, the wiring module 12 including; at least one flexible first substrate 18 that is electrically connected to the electrode terminals 14; and a flexible second substrate 19 that is electrically connected to the first substrate 18 and a device 13, wherein a plurality of first voltage detection lines 20 that are electrically connected to the electrode terminals 14 are formed on the first substrate 18, and the plurality of first voltage detection lines 20 are not lined up in the order of the potentials of the electrode terminals 14 to which the plurality of first voltage detection lines 20 are connected, a plurality of second voltage detection lines 25 that are connected to the plurality of first voltage detection lines 20 are formed on the second substrate 19, and the second substrate 19 has a connection end portion 27 that is connected to the device 13, and in the connection end portion 27, the plurality of second voltage detection lines 25 are lined up in the order of the potentials of the electrode terminals 14 to which the plurality of second voltage detection lines 25 are electrically connected via the plurality of first voltage detection lines 20.

According to the above-described configuration, the plurality of second voltage detection lines 25 can be arranged to be lined up in the order of the potentials of the power storage devices 11 in the connection end portion 27 of the second substrate 19 by employing a simple technique of connecting the first substrate 18 and second substrate 19. The production cost of the wiring module 12 can thus be reduced.

Furthermore, according to the present embodiment, a first temperature measurement conduction path 21 that is different from the first voltage detection lines 20 and that is not lined up in the order of potential is formed on the first substrate 18, second temperature measurement conduction paths 26 that are different from the second voltage detection lines 25 and that are electrically connected to the first temperature measurement conduction path 21 are formed on the second substrate 19, and the positions of the second temperature measurement conduction paths 26 in the connection end portion 27 are different from the position of the first temperature measurement conduction path 21 on the first substrate 18.

According to the above-described configuration, the position of the first temperature measurement conduction path 21, which is not lined up in the order of potential on the first substrate 18, and the positions of the second temperature measurement conduction paths 26 in the connection end portion 27 of the second substrate 19 can be varied. Thus, the flexibility of design can be improved in terms of the position of the first temperature measurement conduction path 21 on the first substrate 18 and the positions of the second temperature measurement conduction paths 26 on the second substrate 19.

In the present embodiment, the first voltage detection lines 20 connected to the electrode terminals 14 of the power storage devices 11, and the first temperature measurement conduction path 21 and thermistors 23 for detecting the temperatures of the power storage devices 11 are formed on the first substrate 18. The thermistors 23 and the first temperature measurement conduction path 21 are disposed between first voltage detection lines 20 that are formed close to the left end portion of the first substrate 18 and first voltage detection lines 20 that are formed close to the right end portion of the first substrate 18. Thus, much work needs to be carried out to rearrange the first voltage detection lines 20 and the second temperature measurement conduction paths 26 so as to be substantially arranged in the order of potential.

In regard to the above-described point, the thermistors 23 for detecting the temperatures of the power storage devices 11 are connected to the first temperature measurement conduction path 21, and the second temperature measurement conduction paths 26 are disposed near the second voltage detection line 25 having the lowest potential out of the plurality of second voltage detection lines 25 in the present embodiment.

The potentials of the second temperature measurement conduction paths 26, which are connected to the thermistors 23 via the first temperature measurement conduction path 21, are relatively close to the lowest one of the potentials of the second voltage detection lines 25. Thus, the second voltage detection lines 25 and the second temperature measurement conduction paths 26 can be arranged so as to be substantially lined up in the order of potential in the connection end portion 27.

Furthermore, according to the present embodiment, the first voltage detection lines 20 and the second voltage detection lines 25 are respectively provided with first voltage detection lands 22 and second voltage detection lands 28, and the first voltage detection lands 22 and the second voltage detection lands 28 are connected via solder 30.

In addition, according to the present embodiment, the first temperature measurement conduction path 21 and the second temperature measurement conduction paths 26 are respectively provided with first temperature measurement lands 24 and second temperature measurement lands 32, and the first temperature measurement lands 24 and the second temperature measurement lands 32 are connected via the solder 30.

The production cost of the wiring module 12 can be reduced because the first substrate 18 and the second substrate 19 can be electrically connected by employing soldering, which is a simple technique.

Furthermore, according to the present embodiment, the solder 30 is covered with sealing portions 31 that contain an insulative synthetic resin.

According to the above-described configuration, the production cost of the wiring module 12 can be reduced because the solder 30 can be sealed by employing a simple technique of covering the solder 30 with a synthetic resin.

Furthermore, according to the present embodiment, the first substrate 18 has a front surface 18A and a back surface 18B, and the first voltage detection lines 20 are formed only on the front surface 18A of the first substrate 18, and the second substrate 19 has a front surface 19A and a back surface 19B, and the second voltage detection lines 25 are formed only on the front surface 19A of the second substrate 19.

Flexible substrates on which conduction paths are formed only on one side thereof can be used as the first substrate 18 and the second substrate 19 because the first voltage detection lines 20 and the second voltage detection lines 25 are respectively formed only on the front surface 18A of the first substrate 18 and the front surface 19A of the second substrate 19. The production cost of the wiring module 12 can thus be reduced.

The wiring module 12 according to the present embodiment is a wiring module 12 for vehicles that is to be used installed in a vehicle 1.

### Embodiment 2

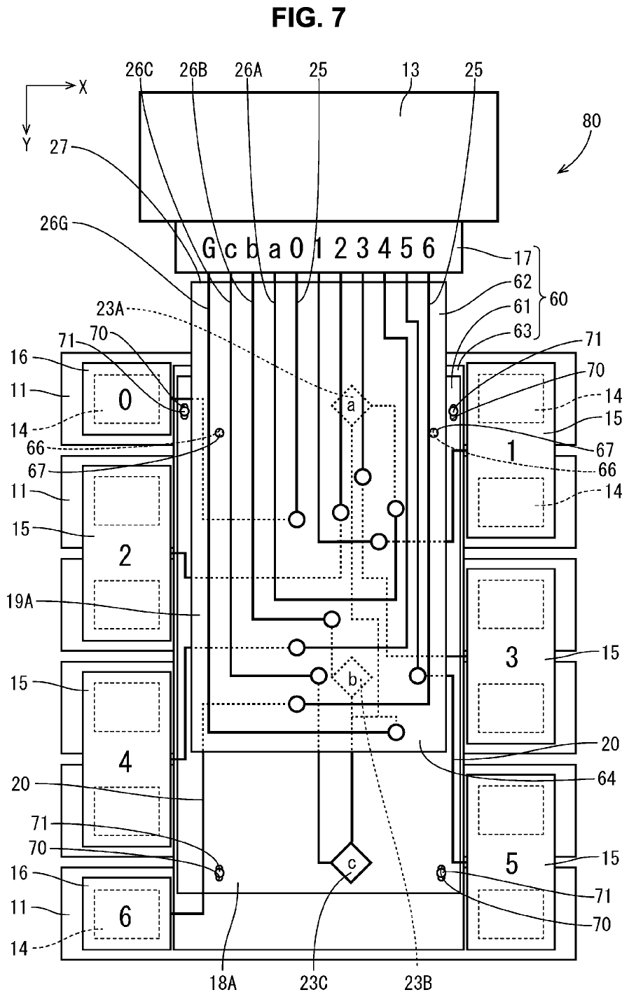

Next, embodiment 2 will be described with reference to FIGS. 7 to 9. As illustrated in FIG. 7, a wiring module 60 of a power storage module 80 according to embodiment 2 includes a protector 63 on which a first substrate 61 and a second substrate 62 are disposed. The protector 63 is obtained by injection molding an insulative synthetic resin. In the present embodiment, the protector 63 is formed in the shape of a plate that extends in the front-rear direction. The protector 63 is formed so as to have an outer shape that is larger than the outer shapes of the first substrate 61 and the second substrate 62.

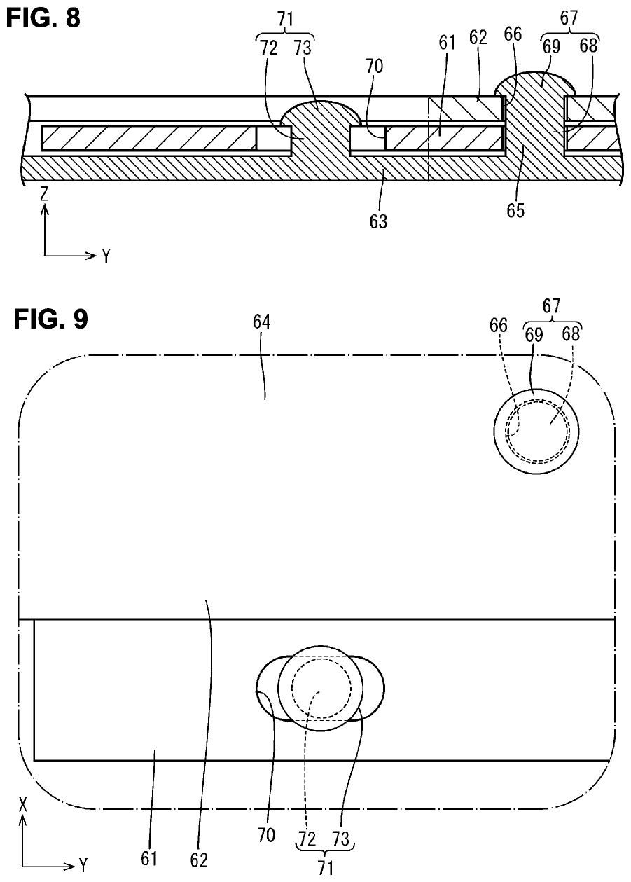

As shown in FIG. 7, the region in which the first substrate 61 and the second substrate 62 vertically overlap is an overlap region 64. As illustrated in FIG. 8, a first reference hole 65 that penetrates the first substrate 61 and a second reference hole 66 that penetrates the second substrate 62 are formed in this overlap region 64. The first reference hole 65 and the second reference hole 66 are disposed at positions that are aligned in the top-bottom direction. As illustrated in FIG. 9, the first reference hole 65 and the second reference hole 66 have circular shapes when seen from above.

In the present embodiment, the first reference hole 65 and the second reference hole 66 are provided at positions in the overlap region 64 that are close to the left and right end portions. Furthermore, the first reference hole 65 and the second reference hole 66 are provided at positions in the overlap region 64 that are close to the rear end portion thereof. In other words, the first reference hole 65 and the second reference hole 66 are provided at positions in the overlap region 64 that are close to the end portion thereof that is close to the module-side connector 17.

As illustrated in FIG. 8, a reference protrusion 67 that protrudes upward is formed on the protector 63 at a position corresponding to the first reference hole 65 and the second reference hole 66. The reference protrusion 67 penetrates the first reference hole 65 and the second reference hole 66 in the top-bottom direction.

As illustrated in FIG. 8, the reference protrusion 67 has a shaft portion 68 that has the shape of a column that extends upward, and a head portion 69 with an increased diameter at the upper end portion of the shaft portion 68. The diameter of the shaft portion 68 is set so as to be the same as or slightly smaller than the diameter of the first reference hole 65 and the diameter of the second reference hole 66. The outer diameter of the head portion 69 is set so as to be larger than the diameter of the first reference hole 65 and the diameter of the second reference hole 66. The first substrate 61 and the second substrate 62 are thus held by the head portions 69 of the reference protrusions 67 in a state in which the first substrate 61 and the second substrate 62 are prevented from being detached upward.

As illustrated in FIG. 7, elongated holes 70 that have an elongated shape in the front-rear direction (one example of an extension direction) are provided so as to penetrate the first substrate 61 in a region that is different from the overlap region 64. In the present embodiment, four elongated holes 70 are provided at positions close to the four corner portions of the first substrate 61.

As illustrated in FIG. 8, a holding protrusion 71 that protrudes upward is formed on the protector 63 at a position corresponding to an elongated hole 70. The holding protrusion 71 penetrates the elongated hole 70 in the top-bottom direction.

As illustrated in FIG. 9, the holding protrusion 71 has a shaft portion 72 that has the shape of a column that extends upward, and a head portion 73 with an increased diameter at the upper end portion of the shaft portion 72. The diameter of the shaft portion 72 is set so as to be smaller than the short diameter (left-right direction diameter) of the elongated hole 70. The outer diameter of the head portion 73 is set so as to be larger than the short diameter of the elongated hole 70. The first substrate 61 is thus held by the head portions 73 of the holding protrusions 71 in a state in which the first substrate 61 is prevented from being detached upward.

As a result of the holding protrusions 71 penetrating the elongated holes 70 and the holding protrusions 71 moving inside the elongated holes 70 in the front-rear direction, the protector 63 and the first substrate 61 can move relative to one another in the front-rear direction.

Since configurations other than those described above are substantially similar to those in embodiment 1, the same reference symbols are provided to the same members, and redundant description is omitted.

According to the present embodiment, the first substrate 61 and the second substrate 62 are disposed on an insulative protector 63, first reference holes 65 and second reference holes 66 that respectively penetrate the first substrate 61 and the second substrate 62 are provided so as to be aligned with one another in an overlap region 64 in which the first substrate 61 and the second substrate 62 overlap, elongated holes 70 that have an elongated shape in a front-rear direction in which the first substrate 61 extends are provided in a region of the first substrate 61 that is different from the overlap region 64, and the protector 63 has reference protrusions 67 that are inserted into the first reference holes 65 and the second reference holes and that hold the first substrate 61 and the second substrate 62 in a locked state, and holding protrusions 71 that are inserted into the elongated holes 70 and that hold the first substrate 61 so as to be movable in the extension direction.

The first substrate 61 and the second substrate 62 are prevented from moving relative to one another because the first substrate 61 and the second substrate 62 are held in a locked state in the overlap region 64 by the reference protrusions 67 inserted into the first reference holes 65 and the second reference holes 66. Furthermore, the first substrate 61 and the second substrate 62 can be positioned based on shaft portions 68 of the reference protrusions 67 because the first reference holes 65 and the second reference holes 66 are circular holes, and the shaft portions 68 of the reference protrusions 67 have a columnar shape. The reliability of the electrical connection between the first substrate 61 and the second substrate 62 can thus be improved.

The first substrate 61 can move in the front-rear direction relative to the protector 63 because the holding protrusions 71 of the protector 63 are inserted into the elongated holes 70 extending in the front-rear direction. Thus, misalignment between the first substrate 61 and the protector 63 can be addressed. This will be described in detail below.

The dimensional accuracy between a first reference hole 65 and a reference protrusion 67 is high because the first reference hole 65 is a circular hole, and the shaft portion 68 of the reference protrusion 67 inserted into this first reference hole 65 has a columnar shape as described above. On the other hand, at positions distant from the first reference holes 65 and the reference protrusions 67, misalignment between the first substrate 61 and the protector 63 occurs due to various causes. For example, causes of misalignment include the manufacturing tolerance of the first substrate 61, the manufacturing tolerance of the protector 63, the assembly tolerance between the first substrate 61 and the protector 63, the difference between the thermal expansion coefficient of the first substrate 61 and the thermal expansion coefficient of the protector 63, etc. Furthermore, if the protector 63 is configured so as to be expandable and contractible in the front-rear direction, misalignment between the protector 63 and the first substrate 61 may also occur as a result of the protector 63 deforming by expanding/contracting.

Even in the above-described situations, misalignment between the first substrate 61 and the protector 63 can be addressed by the first substrate 61 moving in the front-rear direction relative to the protector 63.

In the present embodiment, the first reference holes 65 and the second reference holes 66 are formed close to the end portion of the overlap region 64 that is close to the module-side connector 17. Thus, a force applied to the module-side connector 17 can be taken on by the reference protrusions 67 inserted into the first reference holes 65 and the second reference holes 66 before being transmitted to the portions where the first substrate 61 and the second substrate 62 are connected via the solder 30. Consequently, the reliability of the electrical connection between the first substrate 61 and the second substrate 62 can be improved because a force from the module-side connector 17 can be prevented from being transmitted to the portions where the first substrate 61 and the second substrate 62 are connected in the overlap region 64.

### Other Embodiments

(1) The number of power storage device 11 included in one power storage module 10 is not limited to six, and may be two to five or seven or more.

(2) The power storage devices 11 may be connected in parallel.

Furthermore, sets of a plurality of power storage devices 11 that are connected in series may be connected in parallel, or sets of a plurality of power storage devices 11 that are connected in parallel may be connected in series.

(3) There may be two or more (i.e., a plurality of) first substrates 18.

(4) The number of thermistors 23 may be one, two, or four or more.

Temperature sensors other than thermistors 23 may be used.

(5) The module-side connector 17 may be omitted. In this case, a configuration may be adopted in which the connection end portion 27 of the second substrate 19 is inserted into a card edge connector provided to the device 13. Alternatively, the connection end portion 27 of the second substrate 19 may be soldered to a circuit board disposed in the device 13.

(6) One or more conduction paths may be formed on the back surface 18B of the first substrate 18. Furthermore, one or more conduction paths may be formed on the back surface 19B of the second substrate 19.

(7) A configuration may be adopted in which the solder 30 is sealed by covering the entire front surface 19A of the second substrate 19 in an insulative synthetic resin. As the insulative synthetic resin, a synthetic resin in the form of a film or a sheet may be affixed to the front surface 19A of the second substrate 19, or a synthetic resin having fluidity may be applied to the front surface 19A of the second substrate 19 and then be hardened.

(8) Both or one of the first substrate 18 and the second substrate 19 may be a flexible flat cable.

(9) One or more conduction paths other than voltage detection lines and temperature measurement conduction paths may be formed on the first substrate 18 and the second substrate 19.

(10) The directions in the drawings are used for the convenience of description, and the technique disclosed in the present specification is not limited thereby.

(11) The protector 63 according to embodiment 2 has the shape of a plate. However, there is no limitation to this, and the protector 63 may have any shape.

(12) In embodiment 2, a configuration is adopted in which the first reference holes 65 and the second reference holes 66 are provided at positions in the overlap region 64 that are close to the end portion thereof close to the module-side connector 17. However, there is no limitation to this, and the first reference holes 65 and the second reference holes 66 may be formed at any position in the overlap region 64.

(13) In embodiment 2, a configuration is adopted in which two first reference holes 65 are provided in the first substrate 61, and two second reference holes 66 are provided in the second substrate 62. However, there is no limitation to this, and one first reference hole 65 may be provided in the first substrate 61, and one second reference hole 66 may be provided in the second substrate 62. Alternatively, three or more first reference holes 65 may be provided in the first substrate 61, and three or more second reference holes 66 may be provided in the second substrate 62.

(14) In embodiment 2, a configuration is adopted in which four elongated holes 70 are provided in the first substrate 61. However, there is no limitation to this, and a configuration may be adopted in which one, two, three, or five or more elongated holes 70 are provided.

(15) In the protector 63 according to embodiment 2, a plurality of substrate portions may be joined to one another via a pitch adjustment means that allows the gap between adjacent substrate portions to be adjusted. In this case, even if the gap between the plurality of substrate portions changes, misalignment between the protector 63 and the first substrate 61 can be addressed by the holding protrusions 71 of the protector 63 moving in the front-rear direction inside the elongated holes 70.

### LIST OF REFERENCE NUMERALS

1 Vehicle
2 Battery pack
3 PCU
4 Wire harness
10, 50, 80 Power storage module
11 Power storage device
12, 51, 60 Wiring module
13 Device
14 Electrode terminal
15 Connection bus bar
16 Output bus bar
17 Module-side connector
18, 61 First substrate
18A Front surface of first substrate
18B Back surface of first substrate
19, 62 Second substrate
19A Front surface of second substrate
19B Back surface of second substrate
20 First voltage detection line
21 First temperature measurement conduction path
21A Rear first temperature measurement conduction path
21B Middle first temperature measurement conduction path
21C Front first temperature measurement conduction path
21G Ground first temperature measurement conduction path
22 First voltage detection land
23 Thermistor
23A Rear thermistor
23B Middle thermistor
23C Front thermistor
24 First temperature measurement land
25 Second voltage detection line
26 Second temperature measurement conduction path
26A Rear second temperature measurement conduction path
26B Middle second temperature measurement conduction path
26C Front second temperature measurement conduction path
26G Ground second temperature measurement conduction path
27 Connection end portion
28 Second voltage detection land
29 Through-hole
30 Solder
31 Sealing portion
32 Second temperature measurement land
52 Substrate
52A Front surface of substrate
53 Voltage detection line
54A Rear temperature measurement conduction path
54B Middle temperature measurement conduction path
54C Front temperature measurement conduction path
54G Ground temperature measurement conduction path
63 Protector
64 Overlap region
65 First reference hole
66 Second reference hole
67 Reference protrusion
68 Shaft portion
69 Head portion
70 Elongated hole
71 Holding protrusion
72 Shaft portion
73 Head portion

1. A wiring module disposed on a plurality of power storage devices that have electrode terminals, the wiring module comprising:
at least one flexible first substrate that is electrically connected to the electrode terminals; and
a flexible second substrate that is electrically connected to the first substrate and a device,
wherein a plurality of first voltage detection lines that are electrically connected to the electrode terminals are formed on the first substrate, and the plurality of first voltage detection lines are not lined up in the order of the potentials of the electrode terminals to which the plurality of first voltage detection lines are connected,
a plurality of second voltage detection lines that are connected to the plurality of first voltage detection lines are formed on the second substrate, and
the second substrate has a connection end portion that is connected to the device, and in the connection end portion, the plurality of second voltage detection lines are lined up in the order of the potentials of the electrode terminals to which the plurality of second voltage detection lines are electrically connected via the plurality of first voltage detection lines.

2. The wiring module according to claim 1,
wherein a first conduction path that is different from the first voltage detection lines and that is not lined up in the order of potential is formed on the first substrate,
a second conduction path that is different from the second voltage detection lines and that is electrically connected to the first conduction path is formed on the second substrate, and
the position of the second conduction path in the connection end portion is different from the position of the first conduction path on the first substrate.

3. The wiring module according to claim 2,
wherein a temperature measurement sensor that detects the temperature of the power storage devices is connected to the first conduction path, and
the second conduction path is disposed near the second voltage detection line having the lowest potential out of the plurality of second voltage detection lines.

4. The wiring module according to claim 1, wherein the first and second substrates are electrically connected via solder.

5. The wiring module according to claim 4, wherein the solder is covered by a sealing portion that contains an insulative synthetic resin.

6. The wiring module according to claim 1,
wherein the first substrate has a front surface and a back surface, and the first voltage detection lines are formed only on the front surface of the first substrate, and
the second substrate has a front surface and a back surface, and the second voltage detection lines are formed only on the front surface of the second substrate.

7. The wiring module according to claim 1,
wherein the first and second substrates are disposed on an insulative protector,
a first reference hole and a second reference hole that respectively penetrate the first substrate and the second substrate are provided so as to be aligned with one another in an overlap region in which the first and second substrates overlap,
an elongated hole that has an elongated shape in an extension direction in which the first substrate extends is provided in a region of the first substrate that is different from the overlap region, and
the protector has a reference protrusion that is inserted into the first and second reference holes and that holds the first and second substrates in a locked state, and a holding protrusion that is inserted into the elongated hole and that holds the first substrate so as to be movable in the extension direction.

8. The wiring module according to claim 1, the wiring module being a wiring module for vehicles that is to be used installed in a vehicle.
